(19) United States
(12) Patent Application Publication
(10) Pub. No.: US 2023/0419205 A1
(43) Pub. Date: Dec. 28, 2023

(54) DOMAIN EXPERT PREDICTOR

(71) Applicant: VMWARE, INC., Palo Alto, CA (US)

(72) Inventors: RAMANANDAN NAMBANNOR KUNNATH, Bangalore (IN); Rohit Pradeep Shetty, Bangalore (IN)

(21) Appl. No.: 17/889,424

(22) Filed: Aug. 17, 2022

(30) Foreign Application Priority Data
Jun. 28, 2022 (IN) 202241036947

(51) Int. Cl. G06Q 10/06; G06Q 10/10; G06N 5/02

(52) U.S. Cl. CPC G06Q 10/063112; G06Q 10/103; G06N 5/02

(57) ABSTRACT

Disclosed are various approaches for predicting a domain expert. In one such embodiment, application usage data corresponding to conversations between users of a collaboration messaging service on a particular topic is obtained and used to generate a knowledge graph representing the users involved in the conversations on the particular topic. Thus, based on the knowledge graph, at least one user can be identified as a domain expert for the particular topic, wherein the at least one user is represented in the knowledge graph.

### RELATED APPLICATIONS

Benefit is claimed under 35 U.S.C. 119(a)-(d) to Foreign Application Serial No. 202241036947 filed in India entitled “DOMAIN EXPERT PREDICTOR”, on Jun. 28, 2022, by VMware, Inc., which is herein incorporated in its entirety by reference for all purposes.

### BACKGROUND

In an enterprise setting, cross collaboration among project team members and groups, which are often meeting virtually and remotely, has been challenging. There is currently no way to discern a domain expert in a team or for a particular topic within the enterprise without having to rely on a word-of-mouth approach and personal knowledge of yourself or others. However, it is difficult to acquire such knowledge across an enterprise. This problem is especially prevalent for new employees joining an enterprise and collaborating in a virtual environment.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a block diagram depicting an example implementation according to various examples of the disclosure.

FIG. 2 shows an example of a service flow schematic of an exemplary domain expert prediction system of various embodiments of the present disclosure.

FIG. 3 shows an example knowledge graph according to an example of the disclosure.

FIG. 4 is a flowchart that provides one example illustrating operations of a domain expert prediction system in accordance with various embodiments of the present disclosure.

### DETAILED DESCRIPTION

Disclosed are examples of a domain expert prediction system and related methods that determines a domain expert in an enterprise setting. In situations, where an employee needs to reach out to a domain expert or even in situations where a known domain expert is not available, a user can interact with a domain expert prediction system which would then determine who is the domain expert or the next best person to reach out to with his/her query. In various embodiments, the domain expert prediction system utilizes a knowledge graph service that keeps track of domain specific keywords and interactions between domain users to identify potential domain expert(s).

With most enterprise offices spread around the globe, teams in different geographies are constantly collaborating. However, with remote offices, in-person interaction is less prevalent than before and thus determining the right person to reach out to on a particular topic entails the age-old method of asking around and possibly finding the right person. With the recent influx of remote working due to the pandemic, the inability to find or identify subject matter experts within an organization has become more of a problem over time.

In accordance with embodiments of the present disclosure, a domain expert prediction system is employed that measures or obtains various data points across enterprise collaborations that can be used to determine a domain expert specific to a user's criteria. The various data points can include domain specific keywords and interaction data between domain users (e.g., teammates or group members) such as responsiveness, usage rates, etc. Based on the analysis of the data, enterprise employees can be categorized as an expert or a practitioner (e.g., non-expert) for a particular topic or domain (across a plurality of topics or domains).

Users within an enterprise often use various collaboration messaging services or tools to communicate with other enterprise users, such as email, electronic chats, message boards, video conferencing, telephone conversations, online whiteboards, etc. User collaboration activity can be assessed through use of enterprise applications, network activity through a virtual private network (VPN) tunnel, activity detected through a single sign-on (SSO) service or identity manager, through VDI activity detected for the user, and device metrics that can be collected from a client device that is managed by a management service. In accordance with embodiments of the present disclosure, such electronic communications can be processed and analyzed to form various messaging metrics related to response times between users (e.g., teammates) corresponding to a particular topic and/or which keywords are used in the electronic communications, including identifying the most significant keywords across various groups, such as individual business units, peer groups, teams, etc. By analyzing the electronic communications specific to particular groups, users within the particular group can be ranked based on the collected metrics (e.g., response time and/or keyword usages) and the rankings can be used to train a domain expert prediction system to determine which individual(s) are domain experts within a particular group (e.g., identify an individual that is well versed and immersed in a particular domain or technology area and/or is receptive to answering a user query within the domain or technology area).

Based on insights from the data mined above, employees can be sorted into different categories such as experts, practitioners etc. for a particular topic or domain. In various embodiments, the categorization of employees can be preliminary and can be presented to the subject employee for their consent. For example, an employee can verify his/her data and modify a category tag (expert, practitioner, etc.) associated for a particular domain. Consent provided by a respective employee and/or modifications made by the employee are stored by the prediction system and approved to be considered when responding to a user question or query for a domain expert. Anytime new changes are detected by the prediction system (e.g., a user is categorized as a new expert), consent can be requested by the user.

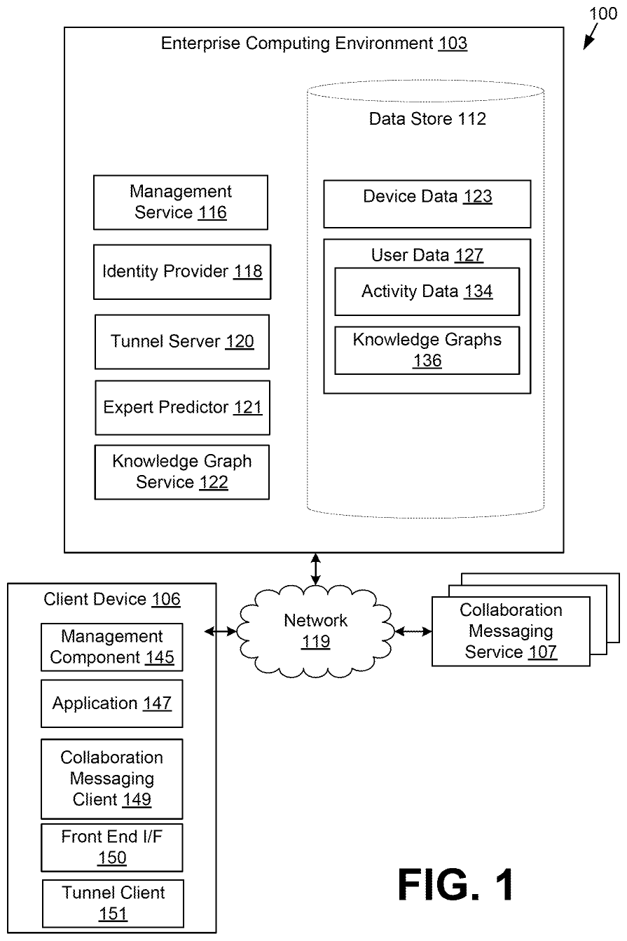

FIG. 1 illustrates an example of a networked environment 100 according to examples of the disclosure. In the depicted network environment 100, an enterprise computing environment 103 is in communication with at least one client device 106 and a domain expert prediction system (also referred to as an “expert predictor”) 121 over a network 119.

The network 119 includes the Internet, intranets, extranets, wide area networks (WANs), local area networks (LANs), wired networks, wireless networks, other suitable networks, or any combination of two or more such networks. The networks can include satellite networks, cable networks, Ethernet networks, and other types of networks.

The enterprise computing environment 103 can be a computing environment that is operated by an enterprise, such as a business or other organization. The enterprise computing environment 103 includes a computing device, such as a server computer, that provides computing capabilities. Alternatively, the enterprise computing environment 103 can employ multiple computing devices that are arranged in one or more server banks or computer banks. In one example, the computing devices can be located in a single installation. In another example, the computing devices for the enterprise computing environment 103 can be distributed among multiple different geographical locations. In one case, the enterprise computing environment 103 includes multiple computing devices that together can form a hosted computing resource or a grid computing resource. Additionally, the enterprise computing environment 103 can operate as an elastic computing resource where the allotted capacity of computing-related resources, such as processing resources, network resources, and storage resources, can vary over time. In other examples, the enterprise computing environment 103 can include or be operated as one or more virtualized computer instances that can be executed to perform the functionality that is described herein.

Various applications or other functionality can be executed in the enterprise computing environment 103. Also, various data can be stored in a data store 112 that can be accessible to the enterprise computing environment 103. The data store 112 can be representative of a plurality of data stores 112. The data stored in the data store 112 can be associated with the operation of the various applications or functional entities described below.

The components executed on the enterprise computing environment 103 can include a management service 116, an identity provider 118, a tunnel server 120, an expert predictor 121 and other applications, services, processes, systems, engines, or functionality not discussed in detail herein. The management service 116 can be executed in the enterprise computing environment 103 to monitor and oversee the operation of one or more client devices 106 by administrators. In some examples, the management service 116 can represent one or more processes or applications executed by an enterprise mobility management (EMM) provider that facilitates administration of client devices 106 of an enterprise that are enrolled with the EMM provider. To this end, the operating system and application ecosystem associated with the client device 106 can provide various APIs and services that allow client devices 106 to be enrolled as managed devices with the management service 116. The management service 116 can include a management console that can allow administrators to manage client devices 106 that are enrolled with the management service 116.

The enterprise computing environment 103 can also execute an identity provider 118. The identity provider 118 can carry out federated user authentication on behalf of an enterprise. For example, the identity provider 118 can implement OAuth, SAML, or similar protocols that allow for federated user authorization or authentication. In examples of this disclosure, the identity provider 118 can also verify a user-and-device token provided by a client device 106 to provide multi-device SSO capabilities as described herein. The identity provider 118 can verify a user's credentials or identity and provide an authentication token, such as a SAML assertion, that can be provided to an application service, e.g., a collaboration messaging service 107, by an application on a client device 106 to authenticate the user's access to a service provided by the application service. The identity provider 118 can issue the authentication token to a client device 106 after verifying the identity of the user and/or client device 106 from which the user is attempting to access the application service. In the context of this disclosure, once a user has authenticated his identify from a first device, the identity provider 118 can authenticate the user from a second device that is managed by the management service 116 upon receiving a user-and-device token from the second device, where the user-and-device token can be verified by the identity provider 118.

The identity provider 118 can verify a user-and-device token issued by the management service 116 to a client device 106 that is enrolled as a managed device and that is associated with a particular user account. The user-and-device token can include information that allows the identity provider 118 to verify the user as well as the device. The user-and-device token can be signed so that the identity provider 118 can verify the authenticity of the token itself. If the user has already established his identity with the identity provider 118 from a first device, and the identity provider 118 subsequently receives a user-and-device token from a second device, the identity provider 118 can establish a SSO session with the second device if the user-and-device token can be validated. Validation can be performed by verifying the signature applied to the user-and-device token as well as the user and device identifying information contained within the token.

In some embodiments, the identity provider 118 can be implemented in a separate computing environment or by a separate entity than the management service 116. The management service 116 can provide an application programming interface (API) with which the identity provider 118 can communicate to verify a user-and-device token or to obtain a public key with which the signature of a user-and-device token can be verified. The management service 116 can also provide an API through which the identity provider 118 can verify user identifiers or device identifiers that are embedded within a user-and-device token.

The management service 116 and/or identity provider 118 can also receive application usage data from applications or a management component installed on the client device 106. Applications on the client device 106 can report time and date information associated with application usage, such as a number of interactions, via a collaboration messaging application or service, between team members on various topics, number of questions asked by team members, number of answers or replies given on specific topics by team members, a number of specific topics a team member is or has worked on, identification of documents authored by team members or commented on by team members for various topics, etc.

Additionally, cloud-based services can report login and logout information to the management service 116 or identity provider 118. A SSO client application that operates as a hub to access enterprise applications can be installed on a client device 106 and report usage of enterprise applications to the management service 116 or identity provider 118.

The management service 116 or identity provider 118 can also obtain usage of VDI (Virtual Desktop Infrastructure) resources associated with a user from a VDI infrastructure environment. A VDI infrastructure environment can utilize the identity provider 118 for identity management and also to report usage data to the management service 116 in some instances.

The tunnel server 120 can provide a virtual private network connection, or a VPN tunnel to an enterprise or private network. The VPN tunnel can be provided to client devices associated with users of the enterprise. The VPN tunnel can be initiated by a tunnel client running on a client device 106 and terminated at the tunnel server 120. The tunnel server 120 can utilize TLS, SSL, or other encryption methodologies to secure a network connection between the client device 106 and the tunnel server 120. The network connection can also be specific to certain apps that are running on the client device 106, such as a tunnel client or other applications on the client device 106 that utilize per-app VPN capabilities of an operating system on the client device 106.

The expert predictor 121 can analyze user data associated with users of the enterprise, such as knowledge graphs 136 generated by a knowledge graph service 122 that link individual team members with topics or subject matters for which they participate in conversing. Then, based on the knowledge graphs, the expert predictor 121 can generate a list of team members that are ranked based on their expertise for an individual topic and/or can generate a topic expert score for individual team members based on messaging metrics. Accordingly, the knowledge graph service 122 can derive the knowledge graph of a user based upon observation of previous behavior with other users within a project team or group. For example, behavior over a period of time can be observed and knowledge graph can be formed based upon the observed behavior (e.g., communications over a communication channel with other users).

Knowledge graphs 136 can be stored in the data store 112 in association with a user. The expert predictor 121 can update the knowledge graph of a user periodically, such as according to a regular schedule. The data stored in the data store 112 can include device data 123, user data 127, and potentially other data. Device data 123 can include records to client devices 106 that are enrolled as managed devices with the management service 116. A record within device data 123 can include various security settings selected for enforcement on a client device 106 that is enrolled with the management service 116. Accordingly, a device record can include a device identifier associated with a device, such as the client device 106 and other data associated with managed devices. In some examples, device data 123 can also identify a user associated with or assigned to a particular client device 106. A device record can also store other device specific information, such as a device type, operating system type or version, applications that are required or optional for the device, or an enrollment status of the device. In this scenario, the device data 123 can also indicate whether a managed device is a computing device or a peripheral device, such as a printer, scanner, or other device that can be deployed in an environment and associated with a record in a directory service.

User data 127 contains information about user accounts in a user directory. User accounts can be maintained by a directory service or the identity provider 118. The user accounts can be associated with client devices 106 that are enrolled with the management service 116. The user data 127 can be associated the same user accounts that are verified by the identity provider 118. In some implementations, the identity provider 118 can rely upon a separate set of user account data or a user directory to determine whether to issue an authentication token to an application on behalf of the user. In other implementations, the user data 127 is a user directory associated with the identity provider 118, and the management service 116 accesses the user data 127 through an API provided by the identity provider 118.

User data 127 can include profile information about a user, authentication information about a user, applications that are installed on client devices 106 associated with the user, and other user information. For example, user data 127 can include information about client devices 106 that are associated with a user account of the user, enterprise resources to which a particular user has access, such as calendar data, documents, media, applications, network sites, or other resources, including collaborative applications for conversing with other users or team members, such as GITHUB, JIRA, MICROSOFT TEAMS, SLACK, SKYPE, email, etc. The user data 127 can also identify one or more user groups or teams of which a particular user is a member, which can in turn define the access rights of the user to one or more enterprise resources as well as identify which applications should be deployed to a client device 106 associated with the user. To this end, the user data 127 can further identify one or more device identifiers that can uniquely identify client devices 106 that are associated with a user account of the user.

User data 127 can also include activity data 134 and the knowledge graph(s) 136. Activity data 134 can represent usage data that can be collected by the management service 116, identity provider 118, tunnel server 120, and management component 145. Activity data 134 can represent network activity, such as via the tunnel server 120, application usage data, usage data as determined by activity on the identity provider 118 and other indications that a user is potentially working or using enterprise information technology resources.

The various collaboration messaging services, such as an email service, chat service, whiteboard service, message board service, etc. can be a computing environment that is operated by an enterprise, such as a business or other organization. The collaboration messaging service 107 includes a computing device, such as a server computer, that provides computing capabilities. Alternatively, the collaboration messaging service 107 can employ multiple computing devices that are arranged in one or more server banks or computer banks. In one example, the computing devices can be located in a single installation. In another example, the computing devices for the collaboration messaging service 107 can be distributed among multiple different geographical locations. In one case, the collaboration messaging service 107 includes multiple computing devices that together can form a hosted computing resource or a grid computing resource. Additionally, the collaboration messaging service 107 can operate as an elastic computing resource where the allotted capacity of computing-related resources, such as processing resources, network resources, and storage resources, can vary over time. In other examples, the collaboration messaging service 107 can include or be operated as one or more virtualized computer instances that can be executed to perform the functionality that is described herein.

The collaboration messaging service 107 can be hosted by a third party and provide messaging and/or chat services to users of the enterprise. Access to the collaboration messaging service 107 can be federated to the identity provider 118 in some examples. As an example, users can utilize a collaboration messaging client application, such as a chat or email client or a user interface generated by the collaboration messaging service 107 to access messages, calendar, contacts, and other data (e.g., client applications for GITHUB, JIRA, MICROSOFT TEAMS, SLACK, SKYPE, email, etc.). Users can also create email messages, appointments, meetings, and perform other tasks.

The client device 106 can represent multiple client devices 106 coupled to the network 119. The client device 106 includes, for example, a processor-based computer system. According to various examples, a client device 106 can be in the form of a desktop computer, a laptop computer, a personal digital assistant, a mobile phone, a smartphone, or a tablet computer system. The client device 106 can represent a device that is owned or issued by the enterprise to a user, or a device that is owned by the user. The client device 106, when provisioned, can be enrolled with the management service 116 as a managed device of the enterprise.

The client device 106 can execute a management component 145 that can communicate with the management service 116 to facilitate management of the client device 106. The management component 145 can communicate with the management service 116 to enforce management policies and compliance rules on the client device 106. For example, the management component 145 can enforce data security requirements, install, remove, or update security certificates, or write, modify, or delete certain data from the client device 106. The management component 145 can also monitor network activity of the client device 106, the location of the client device 106, enforce password or personal identification number (PIN) requirements, or any other security or acceptable-use policies that are defined in the management service 116 and sent to the management component 145 over the network 119.

To carry out local management of a client device 106, the management component 145 can be installed and executed with elevated or administrative privileges on the client device 106. In some scenarios, the operating system can allow a particular application or package to be identified as a device owner or a device administrator.

One or more applications 147 can be installed on the client device 106, such as collaboration messaging client applications 149, such as such as an email client, chat client, whiteboard client, message board client, etc. (e.g., client applications for GITHUB, JIRA, MICROSOFT TEAMS, SLACK, SKYPE, etc.). As a managed device that is enrolled with the management service 116, some applications 147 can be installed by the management service 116. In one scenario, the management service 116 can send a request to the management component 145 to retrieve and install a particular application 147 on the client device 106. In this sense, installation of the application is initiated by the management service 116. The management service 116 can also provide configuration data for a particular application 147 that it installed on the client device 106.

The application 147 can be a browser or incorporate browser functionality, such as a WebKit or WebView component, that allows the application 147 to access browser-based data. In some scenarios, the application 147 can be a special-purpose application that accesses data and services provided by a service. In some examples, an application 147 can be instrumented to provide application usage data to the management service 116 or identity provider 118 when the application 147 is launched, during usage, and when a user may quit or log out of an application.

Another example of an application 147 can be an enterprise hub application or SSO application through which a user can authenticate his or her identity and access enterprise applications. Such an application can collect application usage data for applications associated with the enterprise and report the usage data to the management service 116 or the identity provider 118.

A collaboration messaging client application 149 can also be installed on a client device 106 and utilized to access messaging data, calendar data, contacts, and other information accessible using the collaboration messaging client application. The collaboration messaging client 149 can also obtain user availability from a collaboration messaging service 107.

A tunnel client 151 can be installed on a client device 106 to provide a VPN connection that is terminated at the tunnel server 120. The VPN connection can be an encrypted network connection that provides access to internal enterprise networks to the client device 106. The VPN connection, in some instances, can also simply encrypt network traffic between the client device 106 and the network 119 for security purposes. In some implementations, rather than utilizing a tunnel client 151 that sets up a VPN connection with the tunnel server 120, per-app VPN capabilities of an operating system of the client device 106 can be utilized.

According to examples of this disclosure, the expert predictor 121 can determine an individual that is an expert for a topic or subject matter area by analyzing application usage data, network usage data, and/or user data, such as messages or conversations that occur using collaboration messaging services, through network traffic detected using the tunnel client 151 or tunnel server 120. The analysis can involve domain specific keywords and interaction data between domain users (e.g., teammates or group members) such as responsiveness, usage rates, etc. The application usage data can be detected using a hub application that provides access to enterprise applications installed on the client device 106 or that are hosted elsewhere. Application usage data can also be detected by analyzing user activity log data collected by the management service 116 and/or identity provider 118 corresponding to user logins, logouts, and application usage that can be detected or monitored on behalf of an enterprise.

The knowledge graph service 122 can generate or update a knowledge graph for a user periodically. In some examples, the expert predictor 121 can identify an individual as an expert, which can be presented to the individual for their confirmation. The categorization or labeling/tagging of the individual as an expert for a particular topic or subject matter can be approved, rejected, or edited by the individual before the expert status and identification of the individual is made available to another user who is requesting assistance in finding an expert.

As a general matter, a knowledge graph is a structured representation of facts containing entities, relationships, and semantic descriptions. The knowledge graph includes an array of interconnected nodes and each connection represents a relationship with its own properties or attributes. In some embodiments, a portion of the knowledge graph that includes group of nodes can be isolated or extracted, where each node represents various properties, objects, subjects, and constraints, in order to respond to a specific query. In many cases, knowledge graphs can store and convey in a single network a large collection of information. A generic semantic natural language processing engine can then be applied to user queries and retrieve the correct results from the knowledge graph.

Such knowledge graphs can be generated based on conversations or messages between team members with the general topic or subject matter associated with the conversations being determined and used to categorize topic areas or groupings of conversations. The conversations may be isolated as individual word sequences. In such knowledge graphs, each node in the graph can represent different members or users across various conversations, which can be used to identify experts for certain topic areas.

In various embodiments, an automated chatbot system can provide a front-end interface 150 to the expert predictor 121 and provide users with access to information and/or cause actions to be performed regarding one or more queries submitted to the chatbot interface. Based on the information provided by the knowledge graph, the expert predictor service 121 can be equipped to answer user queries involving identification of experts for a particular topic or subject matter.

In another aspect, the expert predictor 121 can obtain user activity data associated with the identity provider 118. Various applications and services are configured to utilize SSO and depend on the identity provider 118 API's for user authentication, providing authentication tokens, refresh tokens, and other authentication activity. In some cases, applications and services can communicate with the identity provider 118 whenever the user accesses the application. Accordingly, the identity provider 118 can generate usage logs for a respective user account within the enterprise. These usage logs can be provided to the knowledge graph service 122, which can use the usage logs to generate knowledge graph(s).

In another aspect, the knowledge graph service 122 can obtain user activity data associated with application usage on a client device 106 of the user. In some examples, a management component 145 running on a client device 106 that is managed by the management service 116 can report application usage data to the management service 116. The application usage data can include the identity of applications as well as a timestamp associated with usage. The application usage data can also be reported by applications on the client device 106 to the management service 116. In another aspect, the knowledge graph service 122 can obtain user activity data associated with VDI usage by a user. In some examples, a VDI infrastructure environment can report VDI usage data to the management service 116 or the identity provider 118. In another aspect, the knowledge graph service 122 can obtain user activity data associated with device usage of a client device 106 of the user. In some examples, a management component 145 or another application running on a client device 106 that is managed by the management service 116 can report device usage data to the management service 116.

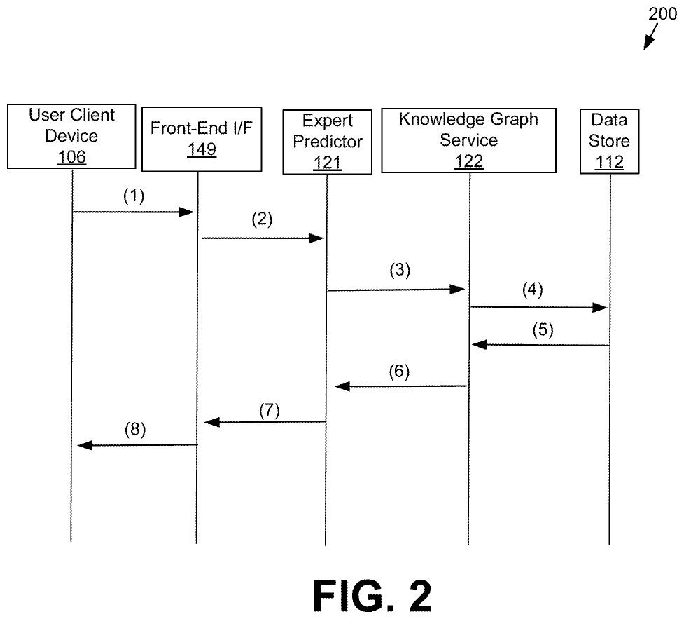

Referring next to FIG. 2, shown is an example of a service flow schematic that depicts operational steps within an exemplary embodiment of a domain expert prediction system. To illustrate the basic flow, a user client device 106 accesses (1) a chatbot client application as a front-end interface 150 to an expert predictor service 121. In an illustrative example, the user can interact with the front-end interface 150 and query the expert predictor service 121 by asking, “Who is the best person in the cybersecurity team to enquire about the DragonEye ransomware attack?” Accordingly, in this example, the chatbot client relays (2) the query to the expert predictor service 121, where the query may undergo processing by a natural language processing (NLP) parser to interpret and determine a context of the underlying query. Based on the context, the expert predictor service 121 calls on (3) a knowledge graph service 122 and obtains (4-5) a knowledge graph query based on the NLP query from a data store 112. As an illustrative example, such a query may resemble: Who is the [best person, “Highest rank”] in [Cybersecurity team, “Target group”] to enquire about [DragonEye, “Topic”]. Thus, the knowledge graph service 122 may obtain (5) a knowledge graph 136 and/or other data documenting relationships defined for cybersecurity team members and their correspondences or conversations involving the “DragonEye” ransomware attack from the data store 112, in this illustrative example. As such, a knowledge graph can be derived from data collected from different sources against a particular topic in a peer group, such as, but not limited to: Number of interactions between team member on the topics; Most number of questions asked; Most number of answers given on the specific topic; Number of topic specific tasks the team member has worked on; Documentation authored or commented on topic specific documentation; etc. The expert predictor service 121 may then be provided (6) the relationship data (e.g., knowledge graph) which is used to determine the best person to interact with based on the data collected.

Accordingly, the expert predictor service 121 can rank or sort users (e.g. employees, team members) into different categories such as experts, practitioners etc. for a particular topic or domain. In various embodiments, an identified user is prompted to consent to their inclusion in the respective category. As such, a user is provided the option of verifying his/her data and modifying the category tag (expert, practitioner etc.) associated for a particular domain. Modifications made by the users are stored by the expert predictor 121 and resurfaced to the particular user for consent anytime new changes are detected by the expert predictor 121.

Based on the above data, the expert predictor service 121 returns (7) to the front-end interface (e.g., chatbot client) a list of team members ranked against the topic. In various embodiments, the ranked list may also include a topic expert score for individuals in order to differentiate between the listed individuals. As an illustrative example, the listing of team members may be provided in the following form to the front-end interface 150:

```
{
  ″Topic″: DragonEye,
  ″Rlist″: [
      {
        ″name″:″ User1″,
        ″email″: ″user1@email.com″,
        ″comms″: [ {″Source″: ″Slack″, ″handle″:″@user1″},
            { ″Source″: ″Teams″, ″handle″:″@user12″}],
          ″TopicExpertScore″:78,
          ″group″:″ Cybersecurity″,
          ″Manager″:″User5″
      },
    {
          ″name″:″ User2″,
          ″email″:″ user1@email.com″,
          ″comms″:[{″Source″: ″Slack″, ″handle″:″@user2″},
            {″Source″: ″Teams″, ″handle″:″@user22″}],
          ″TopicExpertScore″:54,
          ″group″:″ Cybersecurity″,
          ″Manager″:″ User5″
}
]}
```

After the front-end client or interface 150 is provided the listing from the expert predictor service 121, the front-end interface 150 can display (8) the results to the user on the user's client device 106. In an illustrative example, the front-end interface 150 can present the results to the user with given contexts in Natural language as follows:
“Based on enterprise interactions you can reach out to “@user1” or “@user2” in Team “Cybersecurity” whose manager is “User5.”
@User1
Action Button: “Communicate in Slack” [Slack handle Deeplink]
Action Button: “Communicate in Team” [Teams handle Deeplink]
@User2
Action Button: “Communicate in Slack” [Slack handle Deeplink]
Action Button: “Communicate in Team” [Teams handle Deeplink]

In some examples, the expert predictor 121 and/or knowledge graph service 122 can utilize a machine learning process that can operate on the application usage data, network usage data, and/or user data to determine the context of a user's correspondence or conversation with other users. The machine learning process can be trained on a set of application usage data, network usage data, and/or user data and the model can learn by incorporating whether a user asks questions to other users. By initiating questions in a conversation, the model can learn that the user is potentially not an expert in a particular domain or topic area and adjust the corresponding knowledge graph 136 for the user. Alternatively, by receiving questions and answering questions from other users, the model can learn that the user is potentially an expert in the particular domain or topic area and also adjust the corresponding knowledge graph 136. This analysis can involve domain specific keywords and interaction data between domain users (e.g., teammates or group members) such as responsiveness, usage rates, etc.

As such, users within a team or common peer group can be ranked based on the response time and number of usages of these prominent keywords. These data points can be used to train machine learning or statistical models so that a knowledge graph service 122 and/or an expert predictor service 121 can determine and flag individuals as domain experts or well versed and immersed in a particular domain or technology measuring various data points across a user's workday.

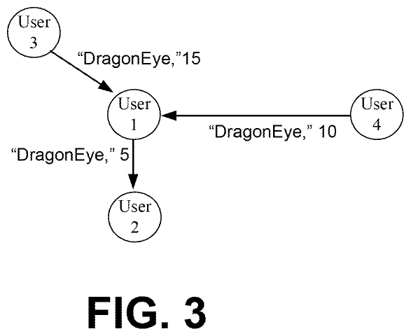

Referring next to FIG. 3, shown is an example knowledge graph 300 that can be generated by the knowledge graph service 122 and used by the expert predictor 121. In the illustrative example shown, individual users (user 1, user 2, user 3, and user 4) are represented as nodes in the knowledge graph 300, where the users may be members of a same work group or team. In one example, the knowledge graph 300 represents a question being directed from an individual to another individual by an arrow (along an edge line) pointing away from the individual asking the question and pointing towards the individual that is receiving the question. In the example of FIG. 3, user 3 has asked user 1 a question involving the DragonEye ransomware on a count of 15 different occasions and likewise, user 4 has asked user 1 a question involving the DragonEye ransomware on a count of 10 different occasions. Thus, based on the knowledge graph 300, the expert predictor 121 service can predict that user 1 is an expert on the DragonEye ransomware topic within this work group. Correspondingly, user 1 has also asked user 2 a question involving the DragonEye ransomware topic on a count of 5 different occasions. Therefore, based on the knowledge graph 300, the expert predictor 121 may also include user 2 in a ranking or list of experts within this work group for the DragonEye ransomware topic. As such, the knowledge graph 300 can be utilized by the expert predictor service 121 to suggest domain experts for a particular topic (e.g., DragonEye ransomware attacks). In some examples, the quantized activity counts can represent a confidence score that represents a likelihood that the user is a domain expert for a given topic. The scale of the confidence score can vary from a zero-to-100 scale, as a non-limiting example, and can factor a plurality of metrics, including response times, message counts, message size (e.g., word counts), keyword usages, etc.

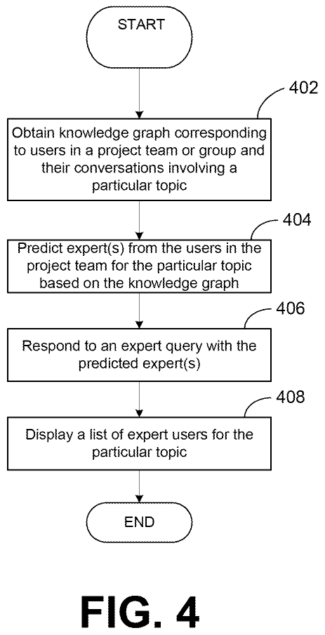

Referring next to FIG. 4, shown is a flowchart that provides one example of how the expert predictor 121 can provide an expert prediction to a requesting client, such as a front-end client or interface 150. Correspondingly, at step 402, the expert predictor 121 can obtain a knowledge graph 136 representing conversational activity corresponding to conversations between users associated with an enterprise for a particular topic or domain. The conversational activity can be application usage data collected from various sources, such as messages exchanged between members of a project team or group within an enterprise via a collaboration messaging server 107. The expert predictor 121 can obtain user activity data associated with network traffic between a client device 106 assigned to the user and a tunnel server 120 associated with the enterprise.

At step 404, the expert predictor 121 can predict one or more experts for the particular topic from the knowledge graph 136 for the users identified in the knowledge graph. The expert(s) can be identified from counts or instances of conversations that a user has with other users regarding the particular topic across various platforms. Thus, in some examples, the counts can be a weighted sum of user activity detected from various usage data inputs.

At step 406, the expert predictor 121 can respond to a request for identification of an expert with a list or ranking of the predicted expert(s). Example initial questions that can be processed by the domain expert prediction system 121 include: Who is the best person to reach out to on a topic in a given team? Which team to consult based on the topic in question? Who is the next best person to consult based on the unavailability of the domain expert? In some examples, the initial request can be a query from a front-end interface 150, such as a chatbot client, of a user for an expert on the DragonEye ransomware attack within the project team that is directed to the expert predictor 121. Accordingly, in other examples, the initial request can be received from other front-end clients, such as an email client, a web client, or any other messaging or chat service clients.

At step 408, a client device 106 of the user can be provided, from the expert predictor 121, the list of expert users within the project team or group for the particular topic and display the list on client device 106. In various embodiments, the displayed list may include links or selectable options to initiate messaging or a conversational dialogue with an expert. In certain embodiments, the provided links or options may be selected based on which platforms are preferred by the intended recipient (e.g., identified expert) and/or may be based on which platforms are preferred by the sender/user of the client device (e.g., as demonstrated by user data for the respective parties).

The flowchart of FIG. 4 shows an example of the functionality and operation herein can be embodied in hardware, software, or a combination of hardware and software. If embodied in software, each element can represent a module of code or a portion of code that includes program instructions to implement the specified logical function(s). The program instructions can be embodied in the form of source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

Although the flowchart of FIG. 4 shows a specific order of execution, it is understood that the order of execution can differ from that which is shown. The order of execution of two or more elements can be switched relative to the order shown. Also, two or more elements shown in succession can be executed concurrently or with partial concurrence. Further, in some examples, one or more of the elements shown in the flowcharts can be skipped or omitted. In addition, any number of counters, state variables, warning semaphores, or messages could be added to the logical flow described herein, for purposes of enhanced utility, accounting, performance measurement, or troubleshooting aid. It is understood that all such variations are within the scope of the present disclosure.

The client device 106, or other components described herein, can each include at least one processing circuit. The processing circuit can include one or more processors and one or more storage devices that are coupled to a local interface. The local interface can include a data bus with an accompanying address/control bus or any other suitable bus structure. The one or more storage devices for a processing circuit can store data or components that are executable by the one or processors of the processing circuit. Also, a data store can be stored in the one or more storage devices.

The management service 116, identity provider 118, expert predictor 121, knowledge graph service 122, and other components described herein can be embodied in the form of hardware, as software components that are executable by hardware, or as a combination of software and hardware. If embodied as hardware, the components described herein can be implemented as a circuit or state machine that employs any suitable hardware technology. The hardware technology can include one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more or more of the components described herein that includes software or program instructions can be embodied in any non-transitory computer-readable medium for use by or in connection with an instruction execution system such as a processor in a computer system or other system. The computer-readable medium can contain, store, or maintain the software or program instructions for use by or in connection with the instruction execution system.

The computer-readable medium can include physical media, such as, magnetic, optical, semiconductor, or other suitable media. Examples of a suitable computer-readable media include, but are not limited to, solid-state drives, magnetic drives, flash memory. Further, any logic or component described herein can be implemented and structured in a variety of ways. One or more components described can be implemented as modules or components of a single application. Further, one or more components described herein can be executed in one computing device or by using multiple computing devices.

It is emphasized that the above-described examples of the present disclosure are merely examples of implementations to set forth for a clear understanding of the principles of the disclosure. Many variations and modifications can be made to the above-described examples without departing substantially from the spirit and principles of the disclosure. All of these modifications and variations are intended to be included herein within the scope of this disclosure.

What is claimed is:

1. An expert prediction system comprising:
at least one computing device;
at least one application executed by the at least one computing device, wherein the at least one application causes the at least one computing device to at least:
obtain application usage data corresponding to conversations between users of a collaboration messaging service on a particular topic;
generate from the application usage data a knowledge graph representing the users involved in the conversations on the particular topic;
obtain a request to provide a domain expert for the particular topic, the request received from a front-end interface to the at least one application; and
based on the knowledge graph, provide at least one user as a domain expert to the front-end interface, wherein the at least one user is represented in the knowledge graph.

2. The system of claim 1, wherein the front-end interface comprises a chatbot client.

3. The system of claim 1, wherein the application usage data is obtained from at least one of a management service or an identity manager, the management service remotely managing a client device associated with the at least one user user and the identity manager comprising a single sign-on service associated with the at least one user.

4. The system of claim 3, wherein application usage data comprises data measured by a management component running on a client device associated with the at least one user, wherein the management component reports application usage to the management service.

5. The system of claim 1, wherein the application usage data comprises specific keywords included in the conversations between the users.

6. The system of claim 1, wherein the application usage data comprises response times of the users in conversing about the particular topic.

7. The system of claim 1, wherein the at least one application causes the at least one computing device to at least:
categorize the users represented in the knowledge graph as an expert or as a practitioner for the particular topic.

8. The system of claim 1, wherein the request further specifies a particular group of users, wherein the knowledge graph only represents users that are members of the particular group of users.

9. A non-transitory computer-readable medium comprising machine-readable instructions, wherein the instructions, when executed by at least one processor, cause a computing device to at least:
obtain application usage data corresponding to conversations between users of a collaboration messaging service on a particular topic;
generate from the application usage data a knowledge graph representing a team of users that are involved in the conversations on the particular topic;
obtain a request to provide a domain expert for the particular topic within the team of users from a client device; and
based on the knowledge graph for the team of users, provide at least one user as a domain expert to the client device, wherein the at least one user is represented in the knowledge graph.

10. The non-transitory computer-readable medium of claim 9, wherein the application usage data is obtained from at least one of a management service or an identity manager, the management service remotely managing the client device associated with the at least one user and the identity manager comprising a single sign-on service associated with the at least one user.

11. The non-transitory computer-readable medium of claim 10, wherein application usage data comprises data measured by a management component running on the client device associated with the at least one user, wherein the management component reports application usage to the management service.

12. The non-transitory computer-readable medium of claim 9, wherein the application usage data comprises specific keywords included in the conversations between the users.

13. The non-transitory computer-readable medium of claim 9, wherein the application usage data comprises response times of the users in conversing about the particular topic.

14. The non-transitory computer-readable medium of claim 9, wherein the instructions, when executed by at least one processor, cause a computing device to at least:
categorize the users represented in the knowledge graph as an expert or as a practitioner for the particular topic.

15. A method comprising:
obtaining, via a computing device, application usage data corresponding to conversations between users of a collaboration messaging service on a particular topic;
generating, via the computing device, from the application usage data a knowledge graph representing the users involved in the conversations on the particular topic;
obtaining, via the computing device, a request to provide a domain expert for the particular topic; and
based on the knowledge graph, providing, via the computing device, at least one user as a domain expert to a client device, wherein the at least one user is represented in the knowledge graph.

16. The method of claim 15, wherein the application usage data is obtained from at least one of a management service or an identity manager, the management service remotely managing the client device associated with the at least one user and the identity manager comprising a single sign-on service associated with the at least one user.

17. The method of claim 16, wherein application usage data comprises data measured by a management component running on the client device associated with the at least one user, wherein the management component reports application usage to the management service.

18. The method of claim 15, wherein the application usage data comprises specific keywords included in the conversations between the users and response times of the users in conversing about the particular topic.

19. The method of claim 15, further comprising categorizing, via the computing device, the users represented in the knowledge graph as an expert or as a practitioner for the particular topic.

20. The method of claim 15, wherein the request further specifies a particular team of users, wherein the knowledge graph only represents users that are members of the particular team of users.
